(19) United States
(12) Patent Application Publication
(10) Pub. No.: US 2010/0175523 A1
(43) Pub. Date: Jul. 15, 2010

(54) LOW-EFFORT PAPER PUNCH

(76) Inventor: CHAN SIU LEUNG, Ho Man Tin (HK)

Correspondence Address: Thomas E. Schatzel;Law Offices of Thomas E. Schatzel, P.C., 200 Altura Vista, Los Gatos, CA, 95032, US

(21) Appl. No.: 12/561,506

(22) Filed: Sep. 17, 2009

(30) Foreign Application Priority Data
Jan. 12, 2009 (CN) 200920050800.9

(51) Int. Cl. B26F 1/32

(52) U.S. Cl. 83/52; 83/597; 83/598

(57) ABSTRACT

A punch comprises a handle and arms on a hinge that change their mechanical advantage against punching heads as the arms pass through the middle part of their travel. Each punching head has a pin near the hinge that passes through slots in the arms radial to the hinge, and through vertical slots tangent to the hinge in punching head towers. A Class-2 type lever arrangement results with the hinge acting as the fulcrum. The mechanical advantage of the handle and arms reaches a maximum when the punching head pins shuttle closest to the hinge. The cutting faces of the punching heads are finished with a saddle contour and set at an angle, with one extending a bit further down into a paper slot than the other. The result is a substantial reduction in effort required of the user.

### BACKGROUND OF THE INVENTION

1. Field of the Invention

The present invention relates to paper punches, and in particular to hole paper punches that reduce the effort required of their users.

2. Description of the Prior Art

The typical hole paper punch is used to put holes along the top edge of sheets of paper so they can be bound together in file folders with fasteners having spaced apart prongs and/or placed in ring binders. Such files and binders are very commonly used in legal and business office filing.

The throats through which a stack of sheets of papers or items being punched must pass is deliberately made very narrow to limit how thick a stack can be attempted. Even so, a thick stack that will fit can be difficult to punch with conventional punches.

An adjustable guide arm is usually mounted to the side of conventional punches that helps the user position the holes being punched along the edge of the sheets. The typical adjustment helps accommodate sheets of various sizes, e.g., A4, letter, and legal size papers.

Conventional paper punches for heavy duty use sometimes employ long operating handles to increase the users' leverage. But these long handles can be expensive and hard to accommodate in a typical office.

Ordinary paper punches also use punching heads with flat faces that contact the papers being punched at the same time. The peak effort to get the punch started can be very high.

### SUMMARY OF THE INVENTION

Briefly, a punch embodiment of the present invention comprises a handle and arms on a hinge that change their mechanical advantage against punching heads as the arms pass through the middle part of their travel. Each punching head has a pin near the hinge that passes through slots in the arms radial to the hinge, and through vertical slots tangent to the hinge in punching head towers. A Class-2 type lever arrangement results with the hinge acting as the fulcrum. The mechanical advantage of the handle and arms reaches a maximum when the punching head pins shuttle closest to the hinge. The cutting faces of the punching heads are finished with a saddle contour and set at an angle, with one extending a bit further down into a paper slot than the other. The result is a substantial reduction in effort required of the user.

These and other objects and advantages of the present invention will no doubt become obvious to those of ordinary skill in the art after having read the following detailed description of the preferred embodiments that are illustrated in the various drawing figures.

### IN THE DRAWINGS

FIG. 1 is a perspective view diagram of a two-hole paper punch embodiment of the present invention;

FIG. 2 is perspective view diagram of a punch mechanism embodiment of the present invention suitable for use in the two-hole paper punch of FIG. 1;

FIG. 3 is a cross sectional view diagram of a punch tower embodiment of the present invention suitable for use in the two-hole paper punch of FIG. 1 and punch mechanism of FIG. 1;

FIGS. 4A and 4B are cut-away side view diagrams of a two-hole paper punch embodiment of the present invention showing how the rotational movement down of the handle is translated into the linear movement of the punching heads;

FIGS. 5A and 5B are side view and cross sectional views of a punching head used in the paper punches of FIGS. 1-3, 4A, and 4B;

FIGS. 6A-6C are diagrams used to explain how the mechanical advantage can be varied by a mechanism found in the paper punches of FIGS. 1-3, 4A, and 4B; and

FIGS. 7A-7D are bottom, side, top, and back view diagrams of a two-hole paper punch like those of FIGS. 1-3, 4A, and 4B.

### DETAILED DESCRIPTION OF THE EMBODIMENT

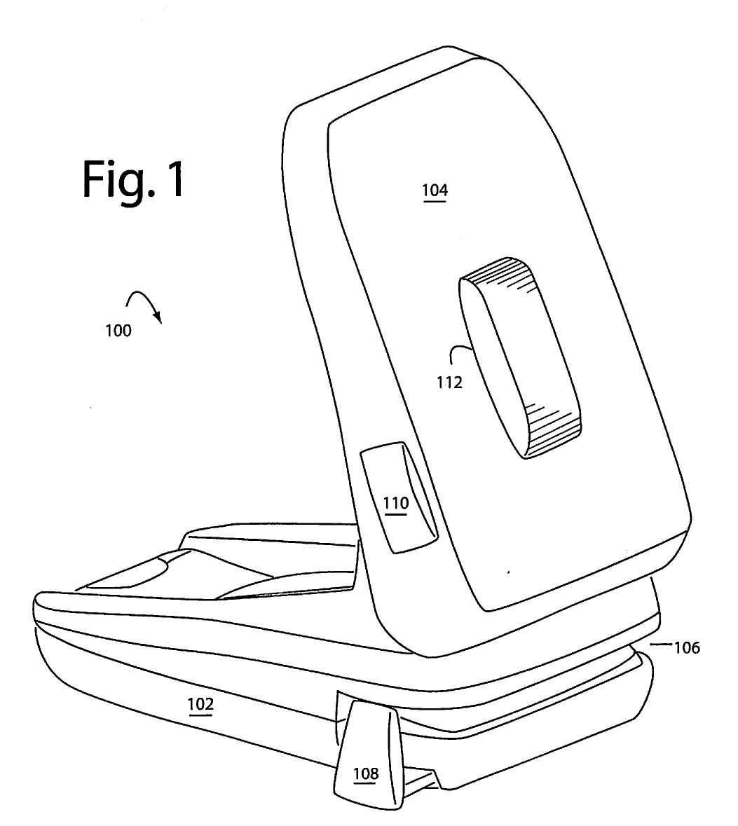

FIG. 1 shows a two-hole paper punch embodiment of the present invention that is referred to herein by the general reference numeral 100. The principles and advantages described herein are also applicable to other standard office punches, e.g., a three-hole side punch. Punch 100 can accommodate and reduce the level of effort needed to punch stacks of thirty sheets of 80 g-weight copy paper.

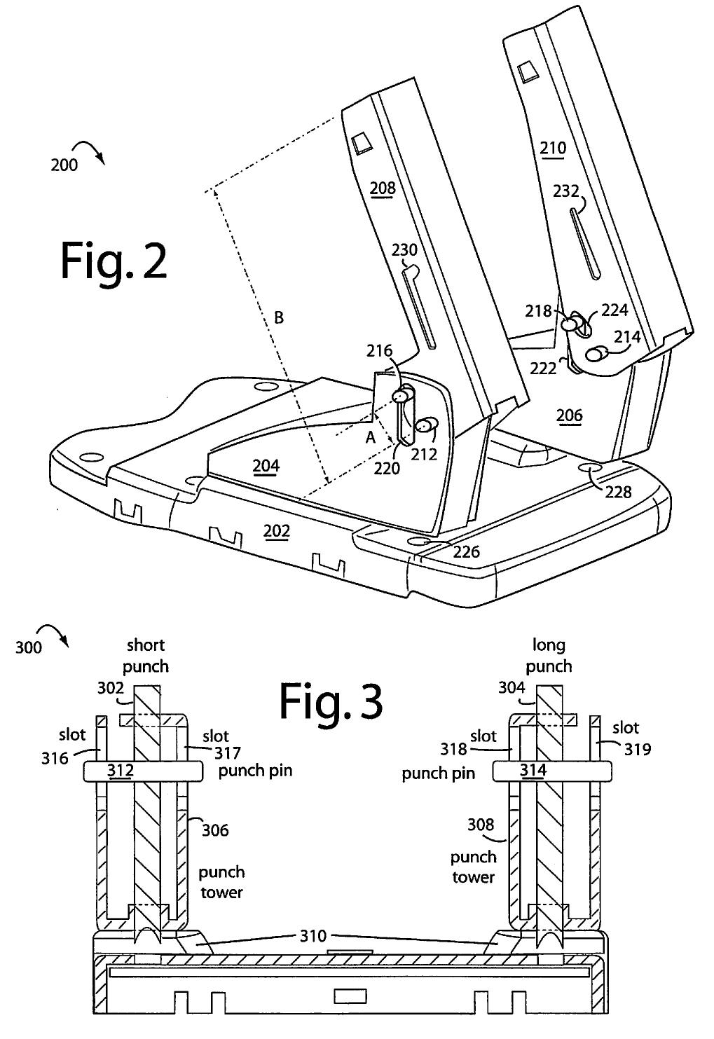

Paper punch 100 has a base 102 to which is hinged a press-down handle 104. Papers to be punched are inserted into a paper slot 106 where they will come between two pairs of punch dies (shown in FIG. 2). An adjustable guide 108 is used to help position the two pairs of punch dies relative to the sheets of paper being punched. A lock knob 110 can be set to keep the press-down handle 104 in the down position, e.g., for storage. A hole 112 in the middle of the press-down handle 104 provides for reception of a decorative symbol.

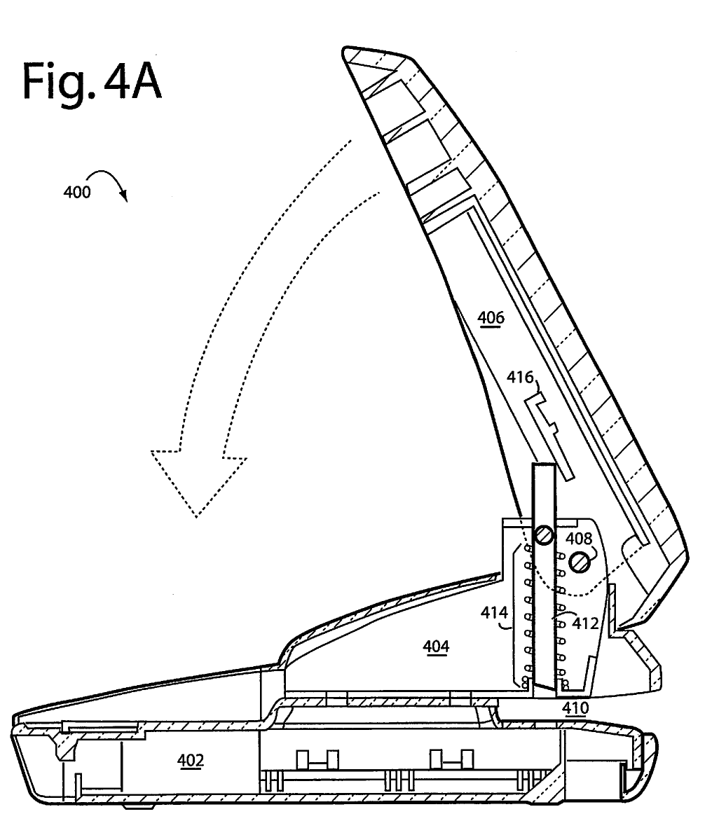

FIG. 2 represents a punch mechanism 200 for use in paper punch 100. Punch mechanism 200 comprises a chassis 202 on top of which are mounted left and right punch towers 204 and 206. A left and a right handle arm 208 and 210 is attached to the left and right punch towers 204 and 206 with a left and a right hinge pin 212 and 214, respectively. A short punch and long punch (shown in FIG. 3) are driven down during operation by press-down handle 104 through left and right handle arms 208 and 210 leveraging against a pair of punch pins 216 and 218. The center-to-center distance between left and right hinge pins 212 and their respective punch pins 216 and 218 is labeled as dimension “A”. The effective leverage arm length of left and right handle arms 208 and 210 is labeled as dimension “B”. The mechanical advantage is therefore B/A.

In embodiments of the present invention, dimension “A” shortens as the press-down handle 104 is pushed downwards. Four tower slots, two of which are visible in FIG. 2, namely 220 and 222 are vertical and only allow punch pins 216 and 218 to move vertically up and down. The middle of slots 220 and 222 can be seen to be closer to left and right hinge pins 212 and 214 than are the top and bottom ends.

Therefore, dimension “A” will continuously vary as punch pins 216 and 218 move from the tops to the bottoms of slots 220 and 222, and be minimum about the middle of such travel. The elevation of left and right hinge pins 212 and 214 relative to slots 220 and 222 will determine where in the travel of left and right handle arms 208 and 210 a maximum in B/A will occur. It is possible for mechanical advantage B/A′ to be double that of B/A″, where A′ is dimension “A” at minimum, and where A″ equals dimension “A” at maximum.

One advantage of this arrangement is that relatively short, fixed length arms 208 and 210 can be used. And compared to conventional punches with the same lengths of handles and arms, embodiments of the present invention will require less effort to operate and can be used to punch through a greater number of paper sheets at one time.

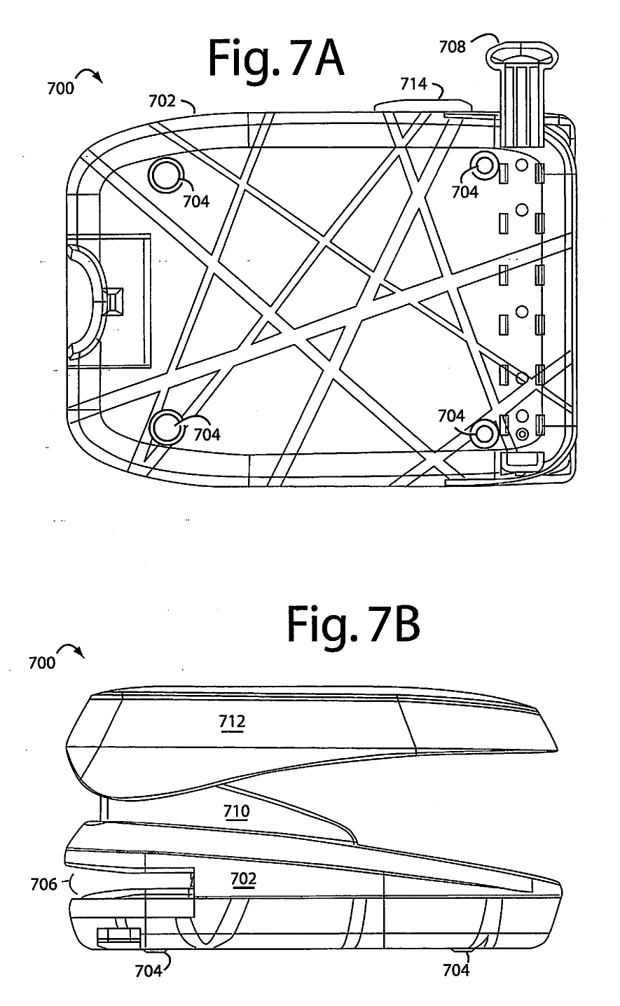

A handle arm slot, e.g., 224, in left and right handle arms 208 and 210 is set in a way that allows dimension “A” to vary as the arms move up and down. FIGS. 6A-6C show this in more detail. A short punch and a long punch, such as 302 and 304 shown in FIG. 3, are driven down during operation by press-down handle 104. The punches will engage a pair of dies 226 and 228, respectively, after passing through a stack of papers. Resistance to the punching will be maximum when the down travel of the punches engage and compress a maximum number of allowable papers in a stack, e.g., thirty pieces of 80 g-weight copy paper. Therefore, that would be the point where it would be best to have a maximum occur in mechanical advantage B/A.

Slots 230 and 232 in handle arms 208 and 210 are part of a handle locking mechanism operated by lock knob 110 (FIG. 1).

FIG. 3 represents a punch tower assembly 300 that is used in paper punch 100 and punch mechanism 200. Seen in cross-section, a short punch 302 and a long punch 304 are mounted inside left and right punch towers 306 and 308. The long punch 304 extends 1.0-3.0 millimeters farther into a paper slot 310 than does short punch 302. The peak effort needed to punch sheets of paper is thus reduced because both punches 302 and 304 are not attempting their initial penetrations at the same time or point in a punching cycle. Two punch pins 312 and 314 are used to drive punches 302 and 304 down as they are guided by four vertical slots 316-319 in left and right punch towers 306 and 308.

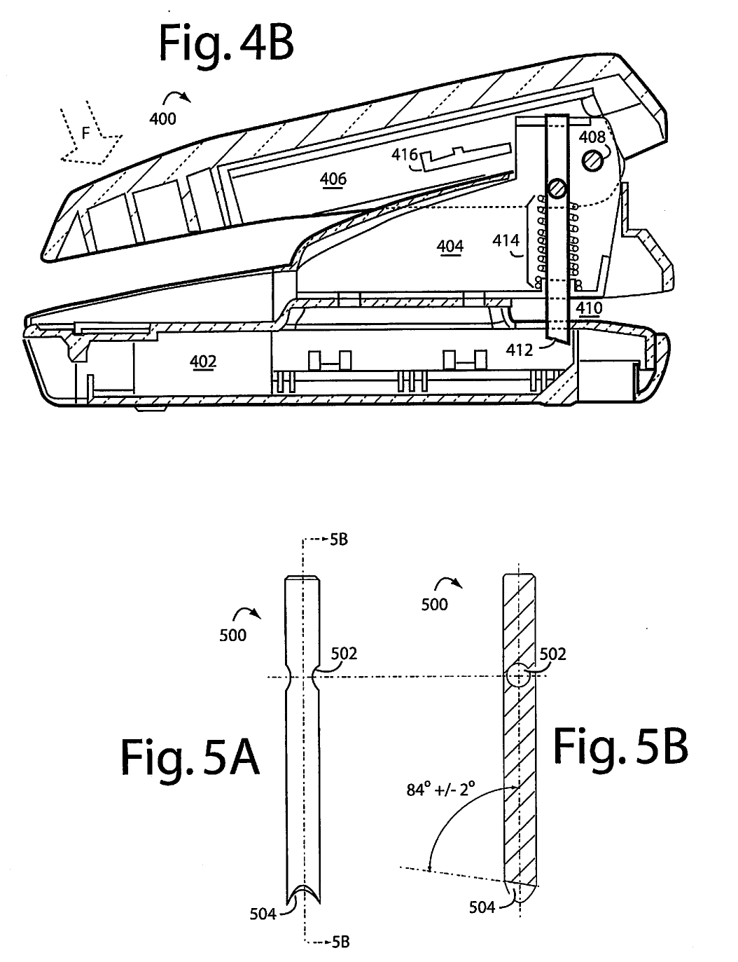

FIGS. 4A and 4B show a paper punch 400 open and closed. Paper punch 400 has a base 402 on which is mounted a punch assembly 404. A press-down handle 406 is hinged to the punch assembly 404 with a pin 408. Papers to be punched are inserted into a paper slot 410 where they will come under a punch 412. As seen in FIG. 4B, pressing down on handle 406 will cause punch 412 to move down into paper slot 410 and compress a spring 414. A slot 416 is used in conjunction with lock knob 110 (FIG. 1) to latch down handle 406 when the paper punch is not being used or is being shipped.

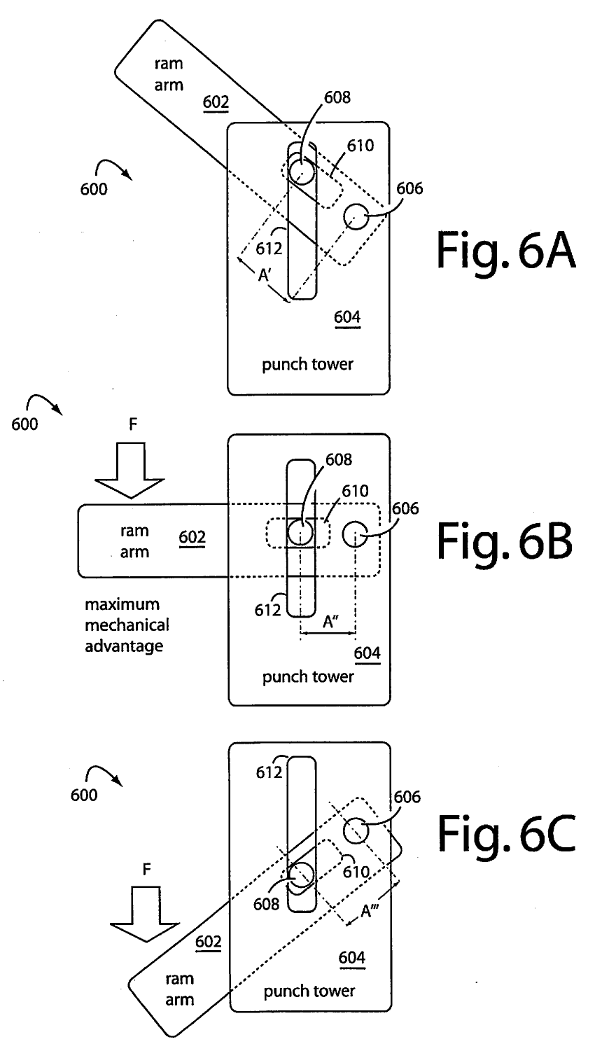

FIGS. 5A and 5B show a punch 500 as used in FIGS. 3, 4A, and 4B. Such should be made of high quality tool steel that will hold an edge and not dull or rust. A hole 502 provides for the insertion of a punch pin, e.g., 216, 218, 312, and 314, in FIGS. 2 and 3. A punch face 504 is cut with a saddle contour and tilted at an angle of about 84°±2° to take advantage of a superior form of point and slicing penetration of the paper sheets. Conventional punches typically employ a flat punch face that requires a lot of brute force to get it to penetrate even a few sheets of paper.

A method embodiment of the present invention reduces the effort required of a user during the operation of a paper punch. A so-called “Class-2” type lever arrangement is made of a handle and arms on a hinge. The hinge acts as the fulcrum and the applied force is provided by a user pressing down at the end of the handle and arms. The connection point of the resistive force of a punching head is articulated to vary according to the position of the handle and arms. The mechanical advantage of the Class-2 type lever arrangement rises to a maximum near a middle of travel. Therefore, a substantial reduction in effort required of the user in punching holes in a stack of papers results during operation.

FIGS. 6A-6C illustrate the kind of “Class-2” type lever arrangement intended, and is referred to herein by the general reference numeral 600. A handle arm 602 is connected to a punch tower 604 by a hinge 606. The applied force is provided by a user pressing down at the distal end of handle arm 602, and hinge 606 functions like a fulcrum. The resisting force of a punching head to downward movement is presented by a pin 608 that passes through a top end of the punching head. A slot 610 that captures pin 608 is radial to hinge 606 and included in handle arm 602. Pin 608 can be seen to shuttle back and forth in slot 610 relative to hinge 606 in the series of FIGS. 6A-6C. A vertical slot 612 in punch tower 604 also captures pin 608, and is tangent to hinge 606. Pin 608 can also be seen to shuttle up and down in slot 612 relative to hinge 606 in the series of FIGS. 6A-6C.

In FIG. 6A, the distance between pin 608 and hinge 606 is represent by symbol A′. In FIG. 6B, the distance between pin 608 and hinge 606 is represent by symbol A″. In FIG. 6C, the distance between pin 608 and hinge 606 is represent by symbol A′″. A maximum in the mechanical advantage applied to the punching head will occur in FIG. 6B because A″ is less than either distance A′ or A′″.

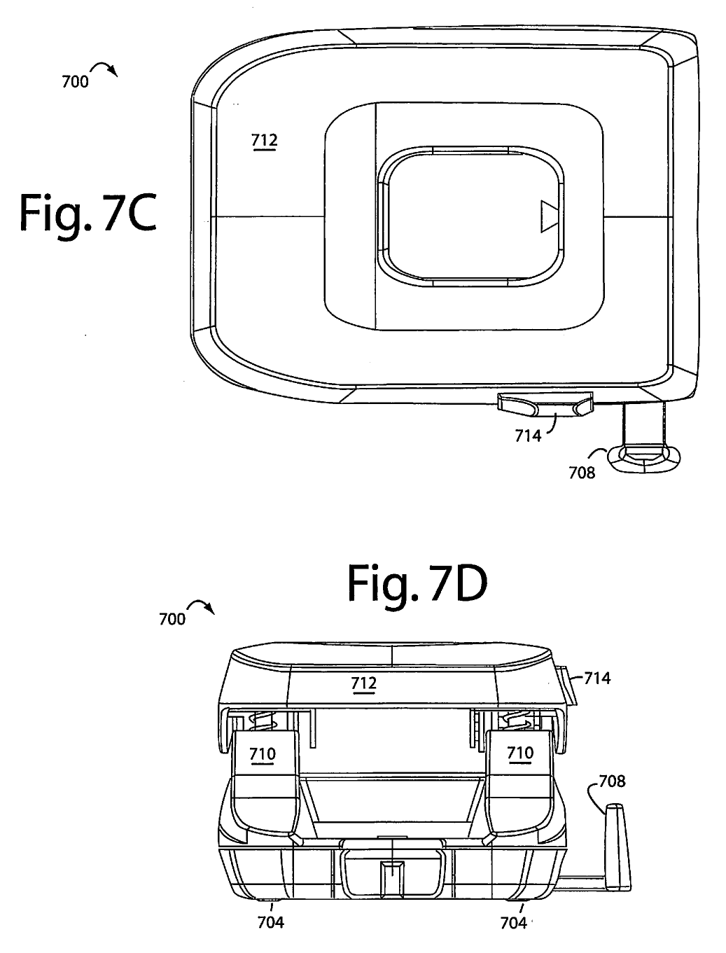

FIGS. 7A-7D show a paper punch 700 with a base 702, soft rubber feet 704, a paper slot 706, a paper guide 708, a punch tower assembly 710, a top handle 712, and a handle lock 714.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A paper punch, comprising:
a handle and arms with a fixed length (B) attached to a punch assembly with a hinge in a lever arrangement against a first punching head; and
a variable force mechanism that varies a distance (A) of a point of contact of the handle from the hinge to the first punching head as the handle and arms are moved through their range of motion;
wherein, the separation distance of the first punching head varies between a maximum (A′) and a minimum (A″) in said distance (A).

2. The paper punch of claim 1, further comprising:
a second punching head disposed in the punch assembly such that force applied by the handle to the second punching head is also multiplied by a lever arrangement formed thereby;
wherein, the variable force mechanism also varies a distance (C) of a point of contact of the handle from the hinge to the second punching head as the handle and arms are moved through their range of motion; and
wherein, the separation distance of the first punching head varies between is a maximum (C′) and a minimum (C″) in said distance (C).

3. The paper punch of claim 1, further comprising:
an offset mechanism that places respective cutting faces of the first and second punching heads at different elevations such that they will be forced to penetrate a common stack of papers being punched at different times and at different operational positions of the handle.

4. The paper punch of claim 1, further comprising:
a cutting face on the punching head, and that has a saddle contour set at an angle of about 84°±2° relative to the length of the punching head.

5. A paper punch, comprising:
a handle and arms on a hinge that change their mechanical advantage against two punching heads as the arms pass through a middle part of their travel; and
at least one pin passing through said punching heads and through slots in the arms radial and near to the hinge, and through vertical slots tangent to the hinge in two punching head towers;
wherein, a Class-2 type lever arrangement results with the hinge acting as the fulcrum; and
wherein, the mechanical advantage of the handle and arms reaches a maximum when said punching head pins shuttle closest to said hinge.

6. The paper punch of claim 5, further comprising:
a pair of cutting faces in the punching heads finished with a saddle contour and set at an angle, with one cutting face extending a bit further down into a paper slot than the other cutting face;
wherein, a substantial reduction in effort required of the user results during operation.

7. A method for reducing the effort required of a user during the operation of a paper punch, comprising:
setting up a Class-2 type lever arrangement of a handle and arms on a hinge, such that the hinge acts as the fulcrum and the applied force is provided by a user pressing down at the end of said handle and arms;
articulating the connection point of the resistive force of a punching head to vary according to the position of said handle and arms such that the mechanical advantage of the Class-2 type lever arrangement rises to a maximum near a middle of travel;
wherein, a substantial reduction in effort required of the user in punching holes in a stack of papers results during operation.

8. The method of claim 7, further comprising:
positioning a cutting face of one punching head differently in elevation than other so that peaks in the punching effort do not occur simultaneously.

9. The method of claim 7, further comprising:
angling a cutting face of said punching head to about 84°±2° relative to its length.
